(19) United States
(12) Patent Application Publication
(10) Pub. No.: US 2007/0244839 A1
(43) Pub. Date: Oct. 18, 2007

(54) Mobile Transaction and Product Delivery System

(76) Inventor: William S. Conley, Irving, TX (US)

Correspondence Address: FULBRIGHT & JAWORSKI L.L.P., 600 CONGRESS AVE., SUITE 2400, AUSTIN, TX, 78701, US

(21) Appl. No.: 11/691,322

(22) Filed: Mar. 26, 2007

Related U.S. Application Data
(60) Provisional application No. 60/785,508, filed on Mar. 24, 2006.

(51) Int. Cl. B67D 5/00; G06F 17/00

(52) U.S. Cl. 705/413

(57) ABSTRACT

Methods and systems for providing a real-time invoice at the time of delivery and collecting payments for the invoice are disclosed. In one respect, a client system may determine an amount of a product delivered, calculate the amount due, and generate an invoice. The client system may also receive payment information and forward such information to a transaction system. The transaction system verifies the payment information and transfers subsequent authorization to the client system.

This application claims priority to provisional patent application Ser. No. 60/785,508 filed Mar. 24, 2006. The entire text of each of the above-referenced disclosure, including figures, is specifically incorporated by reference herein without disclaimer.

### BACKGROUND OF THE INVENTION

1. Field of the Invention

The present invention relates generally to product delivery techniques and systems. More particularly, the present invention involves an integrated system for processing inventory and payment data from deliveries.

2. Description of Related Art

For some products such as, but not limited to, fluid commodities, invoices are dependent on the quantity received from a supplier. These types of transactions do not benefit from conventional pre-pay systems that are generally implemented and employed in catalog, internet, and telephonic fields where a customer pays for goods and/or services, and the merchant provides the goods and/or services upon receipt of the payment.

Conversely, these types of products rely on a “cash-on-delivery” method, as it is known in the shipping industry. A purchaser contacts a merchant and requests delivery of a good. Upon receipt of the goods and the quantity delivered, an invoice is generated (usually remotely and at a later time) and a payment is later rendered after receipt of the invoice, generally to the delivery person or delivery company.

While the cash-on-delivery approach can be effective, it is inconvenient for the consumer as cash, certified checks, and if acceptable, personal checks have to be available at the time of delivery. Alternatively, if a credit account is accepted by the merchant (e.g., credit cards, debit cards, pre-paid cards, EBT, or smart cards), the credit information is collected and subsequently processed at a later time. While credit accounts are more convenient for the purchaser, the merchants are vulnerable to losses, especially when the amount of the invoice is not approved by the issuing bank of the credit account.

To circumvent this issue, conventional technologies use an on-location approval technique. A device, such as an Omni 3750, manufactured by Verifone (San Jose, Calif.) may be used to obtain approval for a credit account transaction. The costs associated with the production of such a device that has its own power supply, housing component, circuitry, etc. are high, especially with the need to outfit an entire fleet of delivery vehicles and/or delivery persons. Additionally, information related to the delivery transaction is not captured using the transaction device and thus balancing inventory, invoices, and tracking of deliveries are cumbersome.

Alternative techniques that are currently being used provide software solutions. A software program or software object is loaded in a target system and is located on the target system hardware. The software program can be integrated with the target system software or can run separately from the target system software. However, these techniques create a data security concern in today's world of electronic payments. Many of the card associations, banks, private card issuers, and government agencies are implementing ever-more strict rules as to the handling of payment data.

The referenced shortcomings above are not intended to be exhaustive, but rather are among many that tend to impair the effectiveness of previously known techniques for payment processing; however, those mentioned here are sufficient to demonstrate that the methodologies appearing in the art have not been altogether satisfactory and that a significant need exists for the techniques described and claimed in this disclosure.

### SUMMARY OF THE INVENTION

The present disclosure provides connectivity of remote collection and/or transaction devices to accomplish purchase transactions as well as tracking and inventory control on a reliable basis with guaranteed security. Additionally, the present disclosure provides for an automatic report system on a delivery vehicle and allows for the running of remote diagnostics or software updates.

It is an objective of the present disclosure to provide a mobile hardware and software operable configured for credit card transactions capabilities, credit card reader support, cellular or satellite communications. In one respect, a base design of the mobile hardware may be a standard hardware platform supporting both stationary and mobile terminal requirements as well as other transaction-based control devices. The terminals may include standard operating system software and drivers readily available. The mobile hardware may be similar or may have the same basic architecture as stationary systems but supporting standard vehicle power and peripherals suitable for mobile applications.

Furthermore, the software communication drivers may be used for standard handheld devices to support data center credit card transactions and to provide for control and monitoring support of various devices. In one respect, the communication drivers may be standard telemetry devices to support the datacenter and to provide for control and monitoring support of various devices (tank monitors, security access, etc.).

A standard interface into the datacenter may be provided to allow any or most POS systems to use the datacenter for their credit card transaction processing.

The terms “a” and “an” are defined as one or more unless this disclosure explicitly requires otherwise.

The term “substantially,” “about,” and its variations are defined as being largely but not necessarily wholly what is specified as understood by one of ordinary skill in the art, and in one-non-limiting embodiment, substantially and its variations refer to ranges within 10%, preferably within 5%, more preferably within 1%, and most preferably within 0.5% of what is specified.

The term “coupled” is defined as connected, although not necessarily directly, and not necessarily mechanically.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a system for processing inventory and payment transaction, in accordance with embodiments of the present disclosure.

FIG. 2 is an input/output diagram of a transaction processor, in accordance with embodiments of the present disclosure.

FIG. 3 is a system diagram, in accordance with embodiments of the present disclosure.

### DESCRIPTION OF THE ILLUSTRATIVE EMBODIMENTS

The disclosure and the various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Client Based System

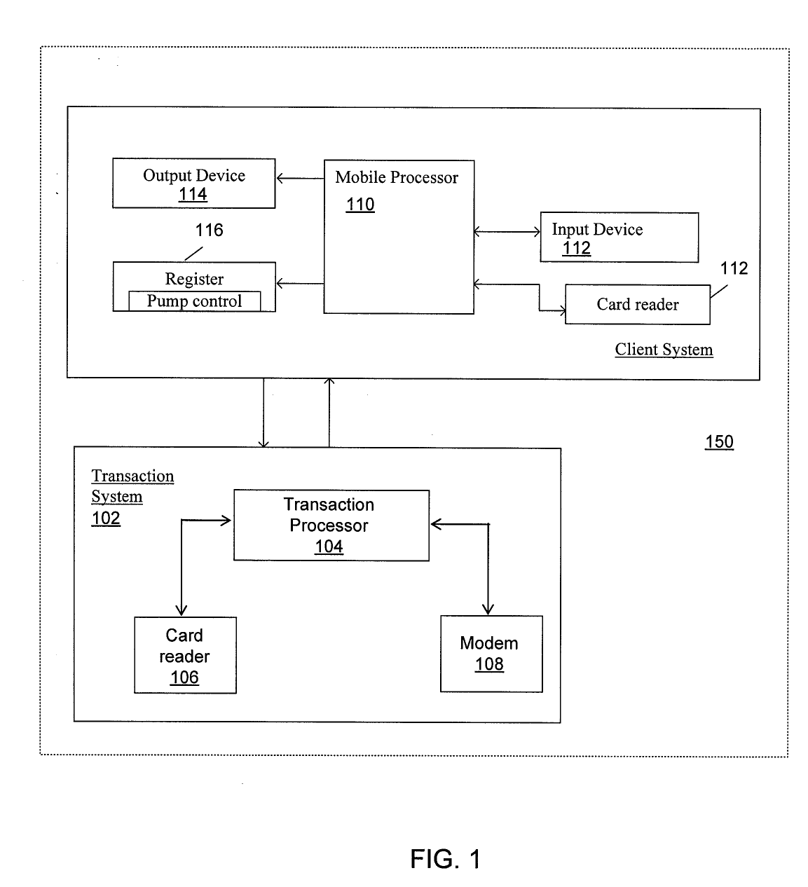

In one respect, the present disclosure provides an integrated solution where a client-based payment system is able to interact with a transaction system to gather payment information from peripherals. Referring to FIG. 1, client-based payment system may include, without limitation, a card reader (for reading data from a credit card, smart card, chip-enabled card, contact-less card, EBT card, debit card, etc), keypad (displays and allows delivery person to input information, e.g., customer number, fuel type, location, etc.), one or more registers (for measuring an amount of fluid dispensed), etc. The client-based payment system may also include a mobile processor for communicating with a transaction processor to trigger certain events and exchange status messages and/or provide instructions to other peripherals of the client based system, etc. Additionally, the mobile processor may collect transaction-related data that describes what is actually being transferred from one entity to another (amount of fluids dispensed, tracking data, etc.).

The client-based payment system may be at a remote location from the transaction system. In one embodiment, the client-based payment system may be coupled to a delivery vehicle that provides, amongst other functions, the storage and transportation of goods. For example, the delivery vehicle may be include a tank for storing and transporting a liquid commodity including, without limitation, aviation fluid, consumer gasoline, LP gas, home or commercial heating oils, propane, liquid petroleum, cryogenic liquids, milk, and/or other liquids. The client-based payment system may be able to determine the amount of liquid that is dispensed to a customer, determine the invoice of the delivered goods (e.g., price per volume), and provide the invoice to the customer. The client-based payment system may subsequently be able to receive payment for the invoice, and in one respect, may be able to provide the credit account information to the transaction system via, for example, a wireless or cellular network. In one respect, a cellular network is used because the network covers a wide geographical area, requires no base antennas to be installed, and already implements a native encryption and security protocol.

If physically separate via an integrated hardware/software system, the client-based part of the payment process can limit its exposure to the transaction system. This accomplishes several goals. There is then less or no need for the client-based system to meet the strict security requirements of the various credit issuer entities. There is still tight integration with the transaction system that is not found with totally separate devices. The client-based system may be serialized and linked with the transaction system that will recognize only qualified devices, thus protecting the entire system from penetration by unauthorized devices.

In one respect, inventory volumes or count-delivered or dispensed may be automatically collected and total prices calculated including local taxes, discounts, etc. For example, the client based system may use electronic registers for liquid materials or RFID tags for packaged products. Such information may be transmitted to a transaction system for processing.

It is important to note that the client-based system need not contain any payment gateways in itself. Its function is to generally interact with the transaction system and act as an intermediary between the transaction system and the credit approval system with integrated security and payment functionality so that if authorized to do so, it may operate not only in an on-line mode, but also operate in an off-line mode.

Transaction System

In one respect, the transaction system collects credit, debit, EBT, smart card, or other card information from the client system and authorizes transactions using cellular or satellite wireless communications to specified processing system. This allows redundant communication. If the cellular connection is not available or degraded, the satellite or another cellular network can be used to connect and exchange the information.

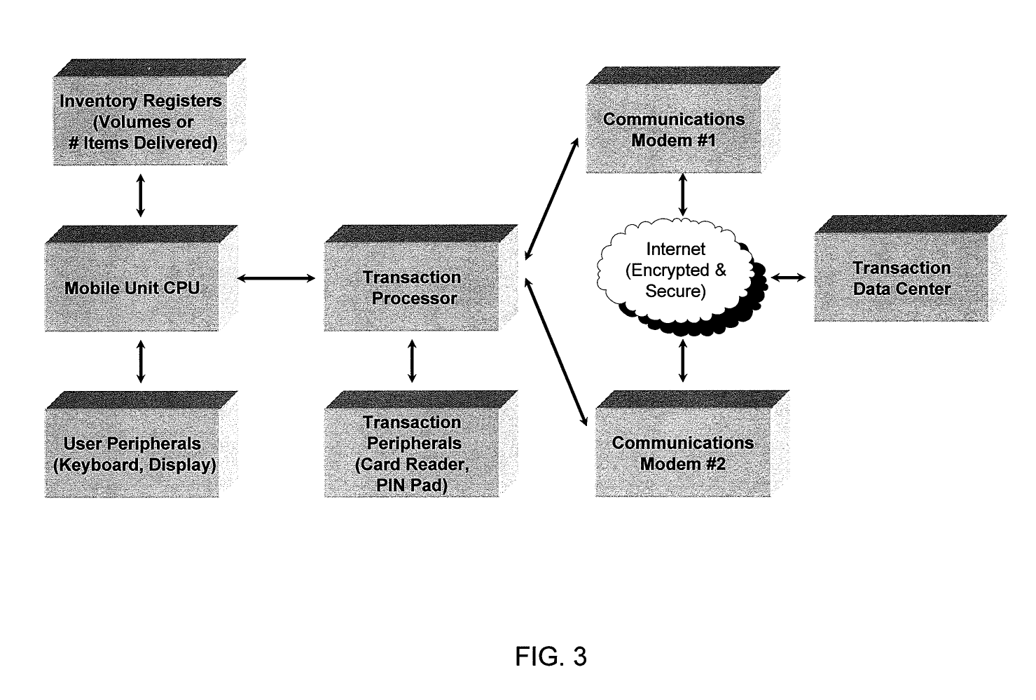

Referring to FIGS. 1 and 3, transaction system 102 may include a transaction processor 104, a card reader (e.g., magnetic strip card reader, smart card reader, pass key reader, a PIN pad, etc.), or in general, a device that provides customer information. The transaction system 102 may also include one or more modems 108 including, cellular and/or satellite modems (collectively “communication modems”) to connect to, for example, the client-based system and credit account processing centers (e.g., issuing banks) to obtain approval for pending transaction.

Alternatively or in addition to the above, the transaction system may use GPS telemetry information about the delivery vehicle itself and thus may allow real-time reporting of location and speed, or location information can be included with the transaction record itself provided to the transaction processor system. This may reduce theft and fraud or at least assist in reconciling activities that have transpired.

Additionally, the transaction system may send alert emails or communicate using other internet standards to notify business of failures on the delivery vehicle, thus allowing for the business of diagnosis problems remotely.

The transaction system may also receive data corresponding to the amount of goods delivered, e.g., the amount of liquid dispensed such that inventory information may be updated real-time or near-real-time. In one respect, for a liquid commodity, a pump control (via register or inventory register of FIGS. 1 and 3, respectively) coupled to a tank monitor may be used to determine the amount of liquid dispensed. The amount delivered information may be provided to the transaction system for processing, among other things, an invoice, inventory checks, and the like.

Referring to FIG. 1, a client system may also be provided. The client system may be separate from the transaction system (separate boards). Alternatively, the client system and the transaction system may be integrated into a hardware component (e.g, chip 150). The client system may include mobile processor 110. Mobile processor 110 may be CPU or programmable control board for processing input data received from input device 112 (e.g., keyboard, voice commands, RFID data, credit card, debit card, smart card or other payment card account information, etc.) and process the data for, among other things, output via output device 114.

The client system may also include register 116 including a control pump mobile processor 110. Register 116 may be used to measure, control, and/or display the amount of invent of inventory dispensed\delivered.

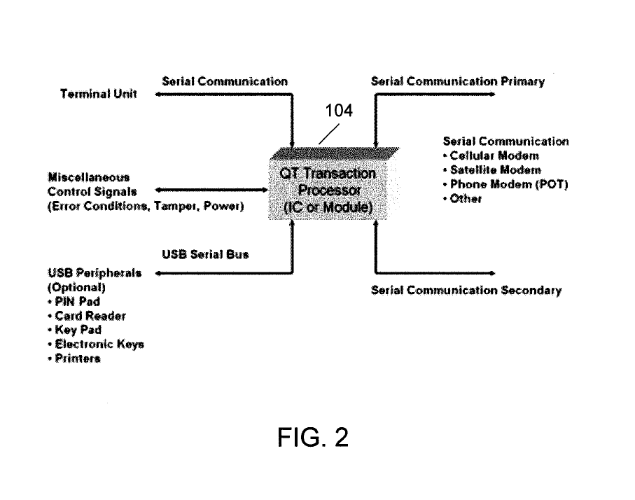

Referring to FIG. 2, the inputs and outputs (I/O) of transaction processor 104, including, but not limited to, serial connections, parallel connections, and USB connections are shown. For each I/O port, an encryption technique, known in the art, may be employed to provide secured encryption on all data received and transmitted by the transaction processor.

In one respect, the transaction processor, or the transaction system as a whole, may provide highly secure encryption on all messages (input and output) via, for example, an auxiliary communication port for failover and/or a USB peripheral bus support. Remote security discovery from host terminal unit software may also be provided to ensure security. The transaction processor may be card brand independent and may accept credit, debit, and/or private accounts. Therefore, new credit cards that issue may not affect the terminal unit. The transaction processor may also include a unit ID embedded in QT/TP, eliminating or substantially reducing spoofing.

The mobile processor and/or transaction processor of FIG. 1 may be any computer-readable media known in the art. The processor may be any computing device capable of executing instructions. In one embodiment, the processor may be part of a personal computer (e.g., a typical desktop or laptop computer operated by a user). In another embodiment, the processor may be part of a personal digital assistant (PDA) or other handheld computing device.

Back Office Interface

The present disclosure may also provide adapters and interfaces that may be couple to back office software packages. In one respect, via a secure internet protocol or other secure networking channels, information relating to a transaction including type of delivery, amount of delivery, payment type, amount paid, generated invoice(s), and the like may be provided to a back office software package. The information may be used for accounting purposes and other business transactions and reports. The data transferred may also be stored as backup for a predetermined amount of time by the back office software' server. In one embodiment, adapters and interfaces for formatting the data may be on the client, data center or a combination may be provided.

Techniques of this disclosure may be accomplished using any of a number of programming languages. For example, the techniques of the present disclosure may be performed on a computer readable medium. Suitable languages include, but are not limited to, BASIC, FORTRAN, PASCAL, C, C++, C#, JAVA, HTML, XML, PERL, etc. An application configured to carry out the invention may be a stand-alone application, network based, or wired or wireless Internet based to allow easy, remote access. The application may be run on a personal computer, a data input system, a point of sale device, a PDA, cell phone or any computing mechanism.

Computer code for implementing all or parts of this disclosure may be housed on any processor capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions according to the methods of the present disclosure. In one embodiment, the processor is a personal computer (e.g., a desktop or laptop computer operated by a user). In another embodiment, processor may be a personal digital assistant (PDA), a gaming console, a gaming device, a cellular phone, or other handheld computing device.

In some embodiments, the processor may be a networked device and may constitute a terminal device running software from a remote server, wired or wirelessly. Input from a source or other system components may be gathered through one or more known techniques such as a keyboard and/or mouse, and particularly may be received form image device, including but not limited to a camera and/or video camera. Output, such as the image mosaic may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used. One or more display panels may also constitute a display. In other embodiments, a traditional display may not be required, and the processor may operate through appropriate voice and/or key commands.

With the benefit of the present disclosure, those having ordinary skill in the art will comprehend that techniques claimed here may be modified and applied to a number of additional, different applications, achieving the same or a similar result. The claims cover all such modifications that fall within the scope and spirit of this disclosure.

1. A method comprising:
obtaining volumetric data corresponding to a dispensed fluid;
generating a real-time invoice based on the volumetric data;
receiving on-site payment information from a purchaser;
transmitting the payment information to a transaction system at a remote location for processing; and
obtaining an authorization code for the payment.

2. The method of claim 1, the payment information comprising credit card information, smart card information, debit card information, or EBT information.

3. The method of claim 1, where dispensing the fluid comprising dispensing a portion of the fluid commodity.

4. The method of claim 1, where dispensing the fluid comprising dispensing substantially all of the fluid commodity.

5. A system comprising:
a transaction processor operably configured to:
receive data corresponding to an amount of goods delivered;
receive data corresponding to an inventory;
generate an invoice; and
collect payment;
a client system coupled to the transaction processor.

6. The system of claim 5, the transaction processor further comprising a card reader for receiving payment information.

7. The system of claim 5, the transaction processor further comprising a modem for transmitting data.

8. The system of claim 5, further comprising a register for detecting an amount of a delivery item.

9. The system of claim 8, the register is operably configured to detect an amount of the delivery item has been delivered.
